(19) United States
(12) Patent Application Publication
(10) Pub. No.: US 2007/0095401 A1
(43) Pub. Date: May 3, 2007

(54) Device, Method and Apparatus

(75) Inventor: David Webster, Monmouthshire (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Energy Equipment Corporation

(21) Appl. No.: 11/584,292

(22) Filed: Oct. 20, 2006

(30) Foreign Application Priority Data
Oct. 21, 2005 (GB) 0521454.9

(51) Int. Cl. F16K 31/36

(52) U.S. Cl. 137/488

(57) ABSTRACT

A device and apparatus is disclosed for coupling to a conduit, and a method to prevent a pressure within at least a portion of the conduit from increasing above a predetermined value. The device comprises a vent having a fluid inlet and a fluid outlet. The vent is selectively actuable between a first closed configuration and a second vent configuration in which there is fluid communication between a fluid inlet and a fluid outlet to thereby vent a fluid. The device also comprises a controller connectable to a hydraulic supply to control selective actuation of the vent. The controller comprises a first surface exposed to fluid from the hydraulic supply and a second surface exposed to fluid from the conduit. The first and second surfaces are arranged such that the vent is actuable into the second vent configuration when the pressure within the conduit increases above the predetermined value.

### FIELD OF THE INVENTION

The present invention relates to a device, method and apparatus for use with a conduit to prevent a pressure within at least a portion of the conduit increasing above a predetermined value. In particular, the device, method and apparatus can be used to prevent a pressure in a conduit such as a pipeline from increasing above the maximum pressure rating and the safe limit for that pipeline.

### BACKGROUND OF THE INVENTION

Oil and gas are extracted from subterranean oil and gas reservoirs. Following extraction, oil and gas are typically transported by pipeline to production facilities. Thick-walled pipelines capable of withstanding high internal pressures are typically used to transport the oil and gas under high-pressures. However, high-pressure rated pipeline is costly and therefore use of this type of pipeline can be prohibitively expensive when there are long distances to be covered from the oil and gas extraction point to a production facility. In order to reduce the cost when oil and gas must be transported over long distances, high-integrity pipeline protection systems (HIPPS) can be used. These systems isolate a proportion of the pipeline downstream from the extraction facility to prevent the pressure within the downstream portion of pipeline rising above a predetermined upper limit. This allows low-pressure rated, thinner walled pipeline to be used for transportation since the HIPPS protects the pipeline from exposure to pressures higher than those for which the pipeline is rated.

A disadvantage of known HIPPS is the high cost associated with the installation and use thereof. This arises mainly from the complex control and actuation systems common with prior art HIPPS.

### BRIEF SUMMARY OF THE INVENTION

According to a first aspect of the invention, there is provided a device to prevent a pressure within at least a portion of a conduit from increasing above a predetermined value, the device comprising:

a vent having a fluid inlet and a fluid outlet wherein the vent is selectively actuable between a first closed configuration in which there is no fluid communication between the fluid inlet and the fluid outlet and a second vent configuration in which there is fluid communication between the fluid inlet and the fluid outlet to thereby vent a fluid; and

a controller connectable to a hydraulic supply to control selective actuation of the vent, the controller comprising a first surface exposed to fluid from the hydraulic supply, and a second surface exposed to fluid from the conduit, wherein the first and second surfaces are arranged in opposing relation and wherein the respective surface areas of the first and second surfaces are selected such that the vent is actuable into the second vent configuration when the pressure within the conduit increases above a predetermined value.

According to the first aspect of the invention, there is also provided a method for preventing a pressure within at least a portion of a conduit from increasing above a predetermined value, including the steps of:

providing a vent having a fluid inlet and a fluid outlet wherein the vent are selectively actuable between a first closed configuration in which there is no fluid communication between the fluid inlet and the fluid outlet and a second vent configuration in which there is fluid communication between the fluid inlet and the fluid outlet to thereby vent a fluid;

providing a controller comprising a first surface and a second surface to control the vent;

arranging the first and second surfaces in opposing relation;

connecting the controller to a hydraulic supply such that the hydraulic supply is in fluid communication with the first surface;

connecting the controller to the conduit such that the conduit is in fluid communication with the second surface;

selecting the area of the first and second surfaces such that the vent is in the second vent configuration when the pressure within the conduit increases above the predetermined value; and

flowing fluid through the conduit.

According to the first aspect of the invention, there is also provided an apparatus for preventing a pressure within at least a portion of a conduit from increasing above a predetermined value, the apparatus comprising:

a hydraulic supply;

a vent having a fluid inlet and a fluid outlet wherein the vent is selectively actuable between a first closed configuration in which there is no fluid communication between the fluid inlet and the fluid outlet and a second vent configuration in which there is fluid communication between the fluid inlet and the fluid outlet to thereby vent a fluid; and

a controller coupled to the hydraulic supply to control selective actuation of the vent, the controller comprising a first surface on which a fluid from the hydraulic supply acts in use and a second surface on which a fluid from the conduit acts in use, wherein the first and second surfaces are arranged in opposing relation and wherein the area of the first and second surfaces are selected such that the vent is moveable into the second vent position when the pressure within the conduit increases above a predetermined value in use.

The first and second surfaces on which the respective fluids act in use can have different surface areas. The surface area of the first surface exposed to a fluid from the hydraulic supply in use, can have a greater surface area than the surface area of the second surface exposed to fluid from the conduit in use.

The hydraulic supply can comprise at least one hydraulic line carrying a hydraulic fluid. The hydraulic supply can be a conventional hydraulic line and can comprise an existing hydraulic supply already provided for use in one or more further applications or a redundancy supply for use as a back up supply for the further application(s).

The fluid inlet can be connectable to a hydraulically actuable valve. The hydraulically actuable valve can be actuable between an open position and a closed position and arranged such that the valve is in the closed position when the vent is in the second venting configuration.

The apparatus can further comprise a hydraulically actuable valve coupled to the conduit and operable to substantially isolate the fluid in the first portion of the pipeline from the fluid in a second portion of the conduit.

The hydraulically actuated valve can be fluidly connected to the fluid inlet of the vent in use.

The device and apparatus can further comprise a pressure control apparatus. The pressure control apparatus can maintain the pressure of fluid exposed to the first surface within a predetermined range. The pressure control apparatus can be provided between the hydraulic supply and the first surface exposed to fluid from the hydraulic supply. The pressure control apparatus preferably acts to ensure the fluid exposed to the first surface in use is maintained within a predetermined range, and preferably at a substantially constant pressure.

The pressure control apparatus can comprise a check valve or non-return valve. The pressure control apparatus can also include an accumulator. The check valve and the accumulator are preferably arranged such that the pressure of fluid exposed to the first surface is substantially constant in use.

According to a second aspect of the invention, there is provided a device to prevent a pressure within at least a portion of a conduit from increasing above a predetermined value, the device comprising:

a vent having a fluid inlet and a fluid outlet wherein the vent are selectively actuable between a first closed configuration in which there is no fluid communication between the fluid inlet and the fluid outlet and a second vent configuration in which there is fluid communication between the fluid inlet and the fluid outlet to thereby vent a fluid;

and a controller to control selective actuation of the vent, the controller comprising a first surface on which a first fluid acts in use and a second surface on which a second fluid from the conduit acts in use, wherein the first and second surfaces each have a different area and are arranged in opposing relation and wherein the area of each of the first and second surfaces is selected such that the vent is actuable into the second vent configuration in use when the pressure within the conduit increases above a predetermined value.

The surface area of the first surface can be greater than the surface area of the second surface on which the second fluid from the conduit acts in use.

The controller can be connectable to a pre-existing hydraulic supply, such that a fluid from the hydraulic supply acts on the first surface in use. The pre-existing hydraulic supply can comprise at least one hydraulic line carrying a hydraulic fluid. The pre-existing hydraulic supply can comprise a hydraulic supply provided for use in one or more further applications or a redundancy supply for use as a back up supply for further application(s). The hydraulic supply can be a high pressure or low-pressure supply line. High pressure supply lines are sometimes preferred in certain embodiments, since the pressure in such lines can sometimes be more stable than in low pressure lines, and in some cases, the controller can be in direct fluid communication via the hydraulic lines with the surface, enabling real time monitoring of the controller from surface, without indirect pressure control apparatus therebetween.

The fluid inlet can be connectable to a hydraulically actuable valve.

The device according to the second aspect of the invention can also comprise a pressure control apparatus as discussed with reference to the first aspect of the invention.

The first surface that is exposed to the first fluid or on which the first fluid acts in use, can indirectly control selective actuation of the vent.

According to another aspect of the invention, there is provided a system for preventing a pressure in a first portion of a pipeline increasing above a predetermined value, the system comprising:

a hydraulically actuated valve for coupling to the pipeline and operable to selectively substantially restrict fluid communication between the first portion of the pipeline and a second portion of the pipeline;

and a controller to control selective actuation of the valve, the controller comprising a first surface adapted to be coupled to a hydraulic supply and exposed to fluid from the hydraulic supply and a second surface in fluid communication with the second portion of pipeline, wherein the first and second surfaces are arranged in opposing relation and wherein the area of the first and second surfaces is selected such that the valve is actuable to substantially restrict fluid communication the first portion of the pipeline and the second portion of pipeline when the pressure within the second portion of the pipeline increases above the predetermined value.

Typically, the first portion of pipeline is downstream from the second portion of the pipeline.

Previously described embodiments of the invention are applicable to this further aspect of the invention, as appropriate.

### BRIEF DESCRIPTION OF SEVERAL VIEWS OF THE DRAWINGS

Embodiments of the invention will now be described as shown and with reference to the accompanying drawings in which:—

FIG. 1 is a schematic diagram of an extraction facility and a production facility with a protection system therebetween;

FIG. 2 is a schematic diagram of a protection system showing a hydraulically actuated valve in an open configuration positioned between two portions of pipeline;

FIG. 3 is a schematic diagram of the protection system of FIG. 2 showing the valve in a closed configuration; and

FIG. 4 is a schematic diagram of a protection system according to another embodiment of the invention.

### DETAILED DESCRIPTION OF THE INVENTION

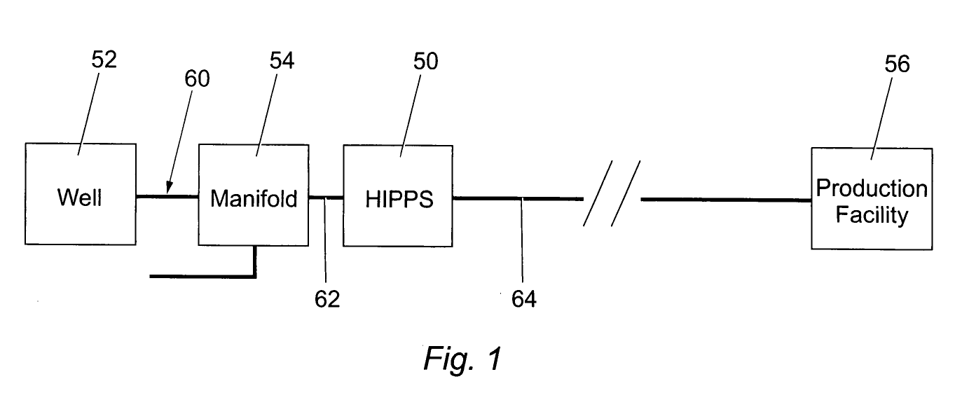

A hydrocarbon extraction facility or well 52 is shown schematically in FIG. 1. Fluids extracted from the well 52 pass through a pipeline 60 to a manifold 54. A high-integrity pipeline protection system (HIPPS) 50 is connected to the pipeline 60 close to the manifold 54 and is capable of hydraulically separating a thick-walled portion of pipeline 62 from a thin-walled portion of pipeline 64. In the present embodiment, the well 52, manifold 54 and HIPPS 50 are provided subsea.

The thick-walled portion of pipeline 62 carrying fluids from the well 52 to the manifold 54 and between the manifold 54 and the HIPPS 50 is capable of withstanding very high-pressures. These components are rated to contain ‘spikes’ in pressure experienced during production of the fluids with a substantial additional safety margin. The thin-walled portion of pipeline 64 transports fluid from the HIPPS 50 to a production facility 56 where the fluids can be processed. According to the present example, the thin-walled portion of pipeline 64 is rated to withstand a specified maximum pressure of 3000 psi (20.7 MPa).

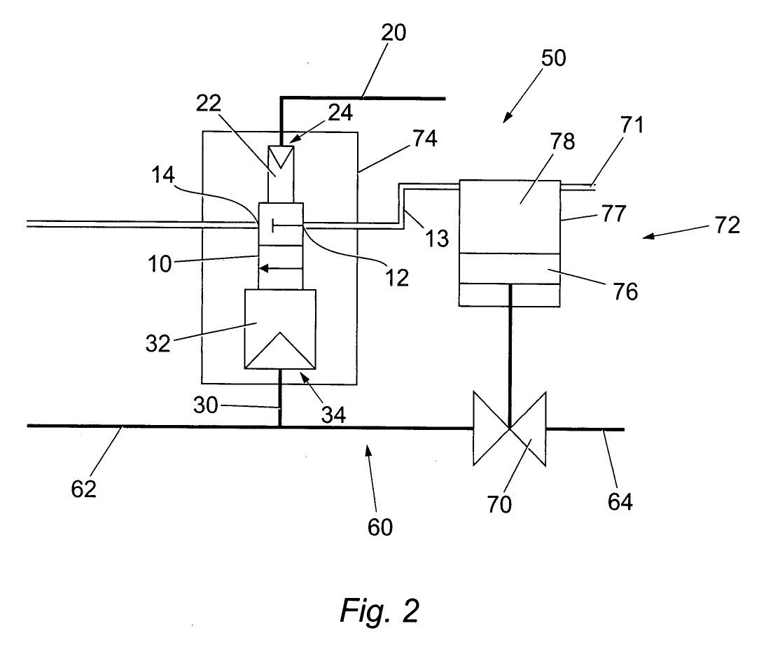

The HIPPS 50 is shown in greater detail in FIG. 2. The HIPPS 50 comprises a valve 70, a hydraulic actuator 72 and a dump valve 74.

The valve 70 is positioned between the thick-walled portion of pipeline 62 and the thin-walled portion of pipeline 64 and is operable to isolate the thin-walled portion of pipeline 64 from the thick walled portion of pipeline 62. FIG. 2 shows the valve 70 in its open position.

The hydraulic actuator is shown generally at 72 in FIG. 2. The hydraulic actuator 72 comprises a piston 76 sealed within a chamber 77. The chamber 77 contains a hydraulic fluid 78 fed via a line 71. The fluid 78 is used to hold the valve 70 in the open position by urging the piston 76 against the bias of a spring (not shown). Thus, in the open position, the valve 70 allows fluid to flow through the pipeline 60 from the thick-walled portion of pipeline 62 to the thin-walled portion of pipeline 64.

The hydraulic actuator 72 is in fluid communication with the dump valve 74 via a line 13. The dump valve 74 comprises a vent in the form of a main stage piston 10. The main stage piston 10 has a fluid inlet 12 and a fluid outlet 14. The main stage piston 10 is moveable from the closed position shown in FIG. 2 in which there is no fluid communication between the fluid inlet 12 and the fluid outlet 14, and a vent position in which there is fluid communication between the fluid inlet 12 and the fluid outlet 14.

A controller is provided in the form of two pilot valves 22, 32 acting in opposing relation on the main stage piston 10. The pilot valve 32 is in fluid communication with the thick-walled portion of pipeline 62 via a conduit 30. The conduit 30 allows fluid from the thick-walled portion of pipeline 62 to act on a surface 34 of the pilot valve 32.

The pilot valve 22 is coupled to an existing hydraulic control module (not shown) via a line 20. In the present embodiment, the line 20 is in fluid communication with a low-pressure hydraulic supply line (not shown) carrying fluid at a pressure of 5000 psi (34.5 MPa) using a T-piece (not shown). Fluid from the hydraulic line 20 acts on a surface 24.

The existing hydraulic control module is a standard part of an extraction facility and has two preinstalled low-pressure hydraulic supply lines and two preinstalled high-pressure hydraulic supply lines, each supplied from a source at the surface and used for feeding hydraulic fluid to various locations at the well 52. The low-pressure hydraulic supply line is used to supply hydraulic fluid to a production control system at a tree and the manifold 54 to operate or control devices. The high-pressure hydraulic supply line is typically used for a hydraulically driven downhole safety valve. The second low- and high-pressure supply lines are installed as redundancy and provide a back-up source of hydraulic fluid. The terms “low” and “high” pressures in relation to supply lines are used in a relative sense since typical pressures of the low-pressure supply lines range between 3000 and 5000 psi (20.7-34.5 MPa).

The supply pressure from the existing hydraulic supply lines may vary with time, since the lines are typically used for other applications and the pressure may vary depending on local demand within the system. In order to maintain a substantially constant supply to the pilot valve 22, the hydraulic line 20 is provided with a check valve (not shown). The check valve prevents the pressure dropping in the hydraulic line 20 downstream from the check valve. An accumulator (not shown) is fitted to the hydraulic line 20 downstream of the check valve. The accumulator provides an additional reserve volume to accommodate moderate leakage of fluid and hence prevent any consequent drop in pressure. If required a means of bleeding pressure can be added to the hydraulic line 20 to prevent substantial overpressure. Thus, the check valve and accumulator allow for fluctuations in the pressure of the hydraulic supply and maintain a substantially constant fluid pressure acting on the surface 24.

One additional advantage of the bleed function is that when the check valve is bypassed this provides full fluid communication with the control system hydraulic supply. This allows the operator at the surface to stabilize the system pressure, e.g. during a period of time where there are no hydraulic functions being operated and the HPU has achieved the set system pressure. At this point, with the check valve bypassed, there is direct hydraulic communication between the HPU at the surface, and the pilot piston surface 24. The pressure gauges at the HPU are calibrated, and calculating the static head and using the pressure reading at the HPU, it is possible to accurately monitor the pressure at pilot piston surface 24.

The surface areas 24, 34 are selected relative to one another based on the known pressure (5000 psi (34.5 MPa)) of the existing hydraulic fluid from the low-pressure supply line in the hydraulic control module and the pressure rating of the thin-walled pipe 62 (3000 psi (20.7 MPa)). An additional safety margin is employed and therefore the pressure at which the valve 70 should preferably close is 2900 psi (20.0 MPa). This pressure of 2900 psi (20.0 MPa) is referred to as the HIPPS trip pressure. Thus, the area of the surface 34 should be 58% greater than the area of surface 24 in order to actuate the valve 70 at the HIPPS trip pressure. Calculation of the surface areas 24, 34 may have to take into account other relevant factors and design features, such as a return spring acting on the main stage piston 10 or the frictional drag of certain components. At the onset of the HIPPS trip pressure, the valve 70 is required to close in order to isolate the thick-walled portion of pipe 62 from the thin-walled portion of pipe 64 to avoid the internal pressure of the thin-walled portion of pipe 64 from exceeding 3000 psi (20.7 MPa). Thus, the pilot valve 32 is actuated at the HIPPS trip pressure in order to move the main stage piston 10 into the vent position.

In normal use, fluid is flowing through the pipeline 60 from the thick-walled portion 62 to the thin-walled portion 64 and the valve 70 is in the open position shown in FIG. 2. Pilot valve 24 is actuated since fluid from the line 20 at 5000 psi (34.5 MPa) is acting on the surface 24 and thus maintains the main stage piston 10 in the closed position. There is no fluid communication between the fluid inlet 12 and the fluid outlet 14 and so the fluid 78 is retained within the chamber 77 acting against the bias of the spring to maintain the piston 76 in the position shown in FIG. 2, which holds the valve 70 in the open position.

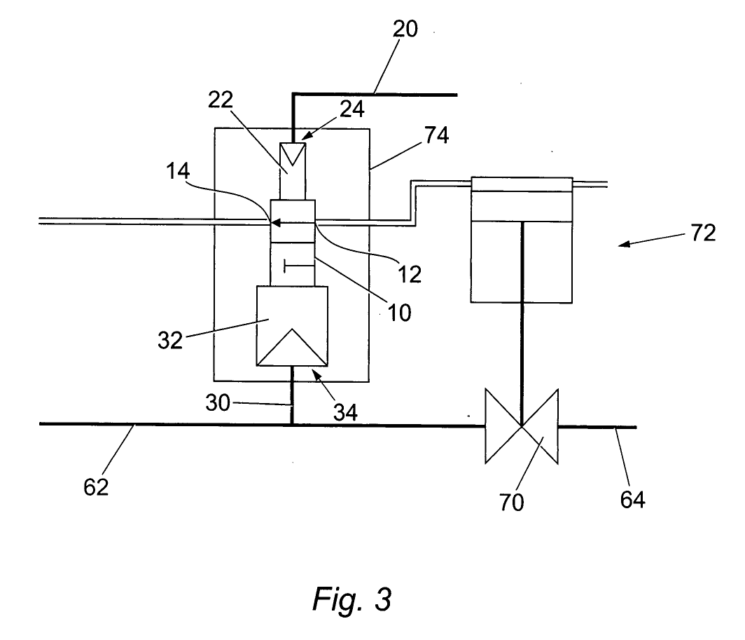

However, when fluid from the thick-walled portion of pipeline 62 acting on the surface 34 is equal to or exceeds the HIPPS trip pressure of 2900 psi (20.0 MPa), pilot valve 22 actuates the main stage piston 10 into the vent position. Thus, fluid is drained from the line 13 when the fluid inlet 12 and the fluid outlet 14 are in fluid communication. The spring moves the piston 76 within the chamber 77 into the position shown in FIG. 3 which causes the valve 70 to close thereby isolating the thin-walled portion of pipeline 64 from the high well pressures and maintaining the pressure within this portion of pipeline 64 below the safe limit of 3000 psi (20.7 MPa).

A major advantage of the invention is that the fluid exposed to the surface 24 can be from any available source. The pressure of fluid from the available source is not required to have any specific relationship to the HIPPS trip pressure. The piloted dump valve 74 is configured to maintain the required relationship between the two pressures. Additionally, the pressure in the thick-walled portion of pipeline 62 never has to exceed the pressure in the hydraulic line 20 acting on the surface 24. Actuation of the HIPPS valve 70 is therefore possible with a lower absolute pressure in the thick-walled portion of pipeline 62 than in the hydraulic line 20.

Another advantage of this arrangement is that the only bespoke components required for the HIPPS system of the present embodiment are the pilot valves 32, 22 that require surface areas 34, 24 to be calculated on the basis of known information.

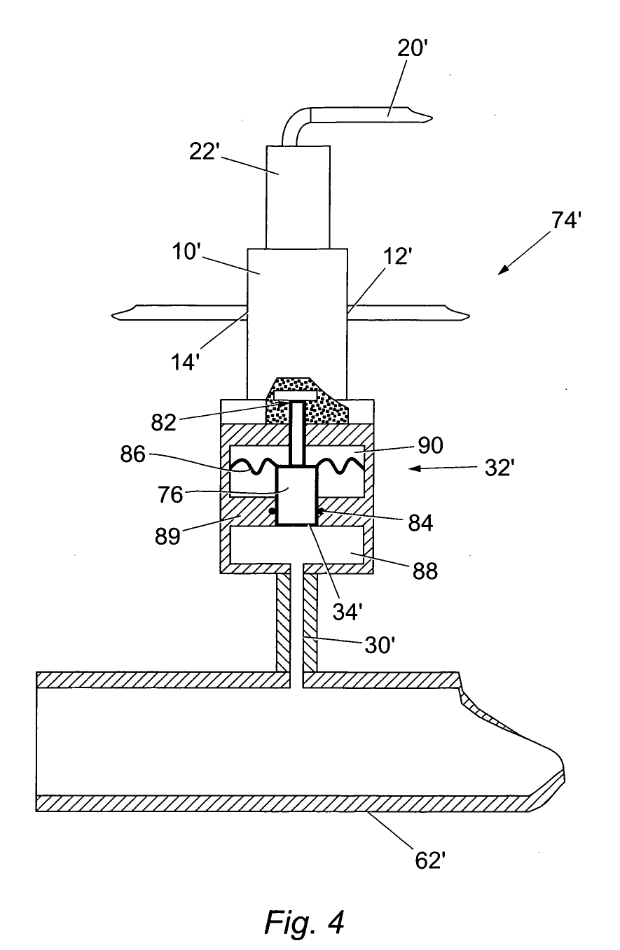

FIG. 4 shows an alternative embodiment of the invention. Like parts are marked with an identical reference numeral followed by a dash. The pilot valve 32′ is provided with a pressure transfer barrier 89.

Fluid from the thick-walled portion of pipeline 62′ is in fluid communication with a chamber 88 via a conduit 30′. Fluid within the chamber 88 acts on the surface 34′ of a piston 76. The piston 76 is provided with a rod 82 at an end distal from the surface 34′. The piston 76 and rod 82 are moveable in response to the pressure of fluid within the chamber 88 acting on the surface 34′ to exert a force on the main stage piston 10′. Fluid within the chamber 88 is isolated from a secondary chamber 90 of the pilot valve 32′ by one or more annular seals 84 and the pressure transfer barrier 89. Additionally, the piston 76 is provided with a metal diaphragm 86 within the secondary chamber 90, which diaphragm 86 is movable axially with the piston 76.

The area of the surface 34′ is selected in the same manner as for the previous embodiment and depends on the required HIPPS trip pressure as well as the pressure of fluid supplied by the hydraulic line 20′ and other relevant factors that may need to be taken into account.

The above embodiment can be usefully employed when safety standards require that produced fluids do not directly act on the controller. The rod 82 which provides an opposing force to the pilot valve 22′ acting on the main stage piston 10′ is separated by a metal barrier (the diaphragm 86) from the produced fluids running through pipeline 62.

Modifications and improvements can be made without departing from the scope of the invention. Although the foregoing embodiments couple the hydraulic line 20 to a low-pressure hydraulic line, the system could be coupled to the high-pressure hydraulic supply line as an alternative. As an alternative to the use of a check valve and an accumulator for maintaining a substantially constant pressure of fluid supplied to the pilot valve 22, a hydraulically actuated valve can be attached to the hydraulic fluid supply. The hydraulically actuated valve can be similar to HIPPS, but on a smaller scale and operable on reverse logic, such that the valve closes when the pressure drops below a predetermined level.

1. A device for coupling to a conduit to prevent a pressure within at least a portion of the conduit from increasing above a predetermined value, the device comprising:
a vent having a fluid inlet and a fluid outlet wherein the vent is selectively actuable between a first closed configuration in which there is no fluid communication between the fluid inlet and the fluid outlet and a second vent configuration in which there is fluid communication between the fluid inlet and the fluid outlet to thereby vent a fluid; and
a controller connectable to a hydraulic supply to control selective actuation of the vent, the controller comprising a first surface exposed to fluid from the hydraulic supply and a second surface exposed to fluid from the conduit, wherein the first and second surfaces are arranged in opposing relation and wherein the respective surface areas of the first and second surfaces are selected such that the vent is actuable into the second vent configuration when the pressure within the conduit increases above the predetermined value.

2. A device according to claim 1, wherein the first and second surfaces exposed to the respective fluids have surface areas calculated according to the pressure of fluid from the hydraulic supply and the predetermined value for fluid pressure at which the vent is actuable into the second venting configuration.

3. A device according to claim 1, wherein the hydraulic supply comprises a hydraulic fluid supply provided for use in at least one of: a further application and a redundancy supply for a further application.

4. A device according to claim 1, wherein the fluid inlet is connectable to a hydraulically actuable valve actuable between an open position and a closed position and arranged such that the valve is in the closed position when the vent is in the second venting configuration.

5. A device according to claim 1, comprising a pressure control apparatus for maintaining the pressure of fluid exposed to the first surface within a predetermined range, wherein the pressure control apparatus is provided between the hydraulic supply and the first surface exposed to fluid from the hydraulic supply.

6. A device according to claim 5, wherein the pressure control apparatus comprises a non-return valve and an accumulator arranged such that the pressure of fluid exposed to the first surface is substantially constant in use.

7. A method for preventing a pressure within at least a portion of a conduit increasing above a predetermined value, including the steps of:
providing a vent having a fluid inlet and a fluid outlet wherein the vent is selectively actuable between a first closed configuration in which there is no fluid communication between the fluid inlet and the fluid outlet and a second vent configuration in which there is fluid communication between the fluid inlet and the fluid outlet to thereby vent a fluid;
providing a controller comprising a first surface and a second surface to control the vent;
arranging the first and second surfaces in opposing relation;
connecting the controller to a hydraulic supply such that the hydraulic supply is in fluid communication with the first surface;
connecting the controller to the conduit such that the conduit is in fluid communication with the second surface;
selecting the area of the first and second surfaces such that the vent is in the second vent configuration when the pressure within the conduit increases above the predetermined value; and
flowing fluid through the conduit.

8. Apparatus for preventing a pressure within at least a portion of a conduit from increasing above a predetermined value, the apparatus comprising:
a hydraulic supply;
a vent having a fluid inlet and a fluid outlet wherein the vent is selectively actuable between a first closed configuration in which there is no fluid communication between the fluid inlet and the fluid outlet and a second vent configuration in which there is fluid communication between the fluid inlet and the fluid outlet to thereby vent a fluid; and
a controller coupled to the hydraulic supply to control selective actuation of the vent, the controller comprising a first surface exposed to a fluid from the hydraulic supply and a second surface exposed to fluid from the conduit, wherein the first and second surfaces are arranged in opposing relation and wherein the area of the first and second surfaces are selected such that the vent is moveable into the second vent configuration when the pressure within the conduit increases above a predetermined value.

9. Apparatus as claimed in claim 8, comprising a hydraulically actuable valve coupled to the conduit and operable to substantially isolate the fluid in a first portion of the conduit from a second portion of the conduit.

10. Apparatus as claimed in claim 9, wherein the hydraulically actuatable valve is actuable between an open position and a closed position in which fluid in the first portion of the conduit is substantially isolated from the second portion of the conduit and wherein the valve is in fluid communication with the fluid inlet of the vent in use such that the valve is in the closed position when the vent is in the second venting configuration.

11. A device to prevent a pressure within at least a portion of a conduit from increasing above a predetermined value, the device comprising:
a vent having a fluid inlet and a fluid outlet wherein the vent is selectively actuable between a first closed configuration in which there is no fluid communication between the fluid inlet and the fluid outlet and a second vent configuration in which there is fluid communication between the fluid inlet and the fluid outlet to thereby vent a fluid;
and a controller to control selective actuation of the vent, the controller comprising a first surface exposed to a first fluid in use and a second surface exposed to a second fluid from the conduit in use, wherein the first and second surfaces each have a different area and are arranged in opposing relation and wherein the area of each of the first and second surfaces is selected such that the vent is actuable into the second vent position in use when the pressure within the conduit increases above the predetermined value.

12. A device according to claim 11, wherein the controller is connectable to a hydraulic supply provided for use in at least one of: a further application and a redundancy supply for a further application.

13. A device according to claim 11, wherein the fluid inlet is connectable to a hydraulically actuable valve actuable between an open position and a closed position and arranged such that the valve is in the closed position when the vent is in the second venting configuration.
